(19) United States
(12) Patent Application Publication
(10) Pub. No.: US 2018/0050319 A1
(43) Pub. Date: Feb. 22, 2018

(54) SUPPORTING COLLECTOR FOR A PACKING COLUMN

(71) Applicant: LINDE AKTIENGESELLSCHAFT, München (DE)

(72) Inventor: Karlmann Kanzler, Altötting (DE)

(21) Appl. No.: 15/552,931

(22) PCT Filed: Mar. 3, 2016
(86) PCT No.: PCT/EP2016/000373

§ 371 Date: Aug. 23, 2017

(30) Foreign Application Priority Data
Mar. 5, 2015 (EP) 15000639.3

(51) Int. Cl. B01J 19/30; B01D 3/00; B22F 3/105

(52) U.S. Cl. CPC B01J 19/305; B33Y 10/00; B22F 3/1055; B01D 3/008

(57) ABSTRACT

A supporting collector for supporting a package, comprising: a plurality of collecting trays for receiving a liquid phase falling from the package; a plurality of guide elements arranged above the collecting trays for guiding the falling liquid phase into the collecting trays; and a supporting grid connected to the guide elements for laying the package on the supporting grid. According to the invention the supporting grid, the guide elements, and the collecting trays are formed integrally on one another and form a supporting unit, wherein the supporting grid, the guiding elements, and the collecting trays are formed by 3D printing and are formed integrally on one another by the 3D printing. A corresponding method for producing a supporting collector is also disclosed.

The invention relates to a supporting collector for a packing column, and also to a method for the production thereof.

The prior art has disclosed packing columns in which a gaseous phase rises up into a structured packing, wherein a liquid phase, which is to be brought into intensive contact with the gaseous phase, in particular for the purpose of mass and/or energy transfer, is delivered, in counterflow, to the packing. At the outlet surface of the packing, which is generally the underside of the packing, the dripping liquid phase exits, and is to be collected and, for example, again delivered to a packing. For arranging packings in a packing column, (steel) supports by means of which the packings are fixed in the packing column in a predefined position are generally provided. Furthermore, for collecting the dripping condensate, collectors by means of which the condensate is collected and or discharged are provided. A disadvantage of the known packing columns is that the installation height of the previously known packing columns along the vertical is relatively large.

Against this background, it is the object of the present invention to at least partially overcome the disadvantages known from the prior art. The features according to the invention are provided by the independent claims, advantageous refinements of which are presented in the dependent claims. The features of the claims may be combined in any technically appropriate way, wherein it is also possible for this purpose to use the explanations from the following description and also features from the figures, which comprise supplementary refinements of the invention.

The object is achieved by a supporting collector for supporting a (structured) packing, wherein the supporting collector has the following components:
a plurality of collecting trays for receiving a liquid phase falling from the packing;
a plurality of guiding elements which are arranged above the collecting trays and which serve for guiding the falling liquid phase into the collecting trays; and
a supporting grid which is connected to the guiding elements and which serves for the placement of the packing onto the supporting grid,
   wherein, according to the invention, the supporting collector has a central run-off tube which extends along a longitudinal axis, wherein the supporting grid, the guiding elements, the collecting trays and the run-off tube are formed integrally on one another and form a supporting unit, wherein the supporting grid, the guiding elements, the collecting trays and the run-off tube are formed by 3D printing and are formed integrally on one another by the 3D printing, and wherein the collecting trays are fluidically connected to the run-off tube and extend in each case from the collecting tube outward in a radial direction to a periphery of the supporting collector, and wherein, proceeding from the run-off tube, the respective collecting tray branches into two collecting tray sections which extend in each case along a radial direction to the periphery of the supporting collector and in the process diverge.

Thus, the supporting collector is in particular set up in such a way that the surface load in design terms, e.g. from a packing in a packing column lying on the supporting collector in a planar manner, is absorbed by the supporting collector itself, and is introduced, for example, onto a supporting ring which is fixed on a casing of the packing column. Particularly preferably, the supporting collector has overall in this case a structure that is optimized in terms of stress.

The supporting grid is especially provided to form an abutment for a component lying thereon, in particular for a packing, which preferably lies with its outlet surface or inlet surface on the supporting grid. Here, the supporting grid distributes, in a planar and more uniform manner, the load of the component lying thereon onto the components of the supporting collector that are arranged under the supporting grid. At the same time, the coverage by the supporting grid is relatively small, and so, as a result of the additional spacing from the further components of the supporting collector due to the supporting grid, the packing arranged thereon can be flowed through better. Here, the grid is likewise connected to the remaining supporting collector, particularly preferably to the guiding elements, or formed integrally on said elements, in a force-transmitting manner. If this creates regions which result in a downwardly closed tray, exit openings through which a liquid phase, which can accumulate in these regions, can flow away are provided at the low points of such regions.

The grid openings of the supporting grid can have a variety of opening cross sections, e.g. square, trapezoidal, circular, honeycomb-shaped, polygonal, etc. Combinations of these cross-sectional forms are also possible.

Furthermore, a supporting grid can be formed from a plurality of struts which extend from the center of the supporting grid outward in a radial direction to the outer boundary or periphery of the supporting collector, wherein such struts are connected integrally to one another via a plurality of circumferential, concentrically-arranged struts.

Furthermore, side faces of the supporting grid at the outer boundary or periphery of the supporting grid can be inclined toward the center such that a boundary flow of a gaseous phase, which flows upward on an inner side of the casing of the packing column, is forced inward by such side faces.

During the operation of the supporting collector, the supporting grid (as also the collecting trays and the guiding elements) preferably extends along the horizontal, specifically in particular over the entire cross section of the packing column.

In principle, all components of the supporting collector may have integrally formed stiffening ribs in order to improve the load-bearing capacity of the supporting collector.

According to a preferred embodiment of the invention it is provided that the central run-off tube extends along a longitudinal axis which in particular runs perpendicularly to the guiding elements and/or the collecting trays. Preferably, the supporting grid, the guiding elements, the collecting trays and the collecting tube are then formed integrally on one another and form said supporting unit, wherein the supporting grid, the guiding elements, the collecting trays and the collecting tube are formed by 3D printing and are formed integrally on one another by the 3D printing.

Furthermore, the collecting trays are fluidically connected to the run-off tube (also see above), wherein the collecting trays preferably open into the central run-off tube in a radial direction. Here, the collecting trays extend in each case from the collecting tube outward in a radial direction to a periphery or an outer boundary of the supporting collector.

It is furthermore provided that, proceeding from the collecting tube, the respective collecting tray branches into two collecting tray sections (also see above) which extend in each case along a radial direction to the periphery of the supporting collector and in the process diverge, wherein the two collecting tray sections in particular include an acute angle.

According to a further preferred embodiment of the invention, it is provided that the two diverging collecting tray sections have in each case a side wall, wherein the two side walls are facing one another, and wherein further collecting tray sections branch off from the two side walls in each case, which sections in particular run parallel to one another and in particular extend in each case along a radial direction to the periphery of the supporting collector.

Here, there is preferably in each case between two adjacent collecting tray sections a gap which serves in particular for allowing the passage of a gaseous phase, such that said phase is able to rise up in a packing that is to be placed onto the supporting grid.

Due to the formation of the guiding elements and also the collecting trays as struts which extend in each case along a radial direction favors, the design of the supporting collector as a supporting unit and furthermore allows good permeability for a rising gaseous phase to the packing lying thereon.

Furthermore, according to a refinement of the invention, it is preferably provided that the guiding elements have in each case at least one guiding element section, which is arranged above an assigned gap such that a liquid phase impinging on the respective guiding element section can flow away from the respective guiding element section and pass into at least one of the two collecting tray sections which run on both sides of the assigned gap above which the respective guiding element section is arranged. The guiding element sections preferably cover in each case the gap assigned to them so that, ideally, the entire liquid phase trickling down from the packing lying on the supporting collector lands in the collecting tray sections.

Proceeding from the run-off tube, at least some of the guiding elements branch into a plurality of, in particular three, guiding element sections. Between two such guiding elements there is preferably arranged in each case a non-branching guiding element which in this respect forms only one guiding element section.

According to a preferred embodiment of the invention, the guiding element sections are furthermore designed in each case as a roof profile. The respective roof profile has in this case two run-off surfaces, which are arranged at an angle to one another and which drop down from an upper edge of the roof profile on both sides such that a liquid phase impinging on the respective roof profile can flow away from the run-off surfaces and into the respectively assigned collecting tray section. The specifically directed run-off of the liquid is assisted by drip noses on the ends of the run-off surfaces. In particular, the roof profile or the respective guiding element section is formed so as to be of triangular cross section, specifically in particular in the form of an isosceles triangle with an upwardly directed apex, whereby a peaked roof or the respective roof profile is formed. The roof profile may furthermore be a solid profile of triangular cross section. As a result, the resistance of the guiding element sections against flexural stresses is advantageously increased.

The collecting trays and the guiding elements are consequently in particular arranged with respect to one another in such a way that, on the one hand, a gaseous phase rising up in a column or a packing column can flow past the collecting trays and guiding elements, while, on the other hand, the liquid phase is preferably deflected by the guiding elements such that, ideally, it can be completely caught in the collecting trays.

According to a preferred embodiment of the invention, it is furthermore provided that the guiding element sections are formed integrally on assigned collecting tray sections via webs, wherein between adjacent webs there is formed in each case a passage opening, in particular for allowing the passage of a gaseous phase, such that said phase is able to rise up into a packing that is to be placed onto the supporting grid. The webs are especially provided to establish a force-transmitting, integral connection between the collecting tray sections and the guiding element sections, and at the same time to ensure that the rising gas can flow through well. In a preferred embodiment, a multiplicity of passages or passage openings are provided for the purpose of achieving a total throughflow area that is as large as possible. The passage openings may be rectangular, square, trapezoidal, circular, elliptical, honeycomb-shaped or polygonal in form. Furthermore, the various passage openings may also be combined with one another.

According to a further preferred embodiment of the invention, the collecting trays and/or the collecting tray sections have a slope toward the central run-off tube such that the liquid passing into the collecting tray sections is accelerated toward the central run-off tube and can be discharged via said tube.

Particularly preferably, the collecting trays or collecting tray sections are designed as channels or troughs that are open at the top.

In the collecting trays, it is possible to provide additional guiding surfaces which assist a flow distribution of the liquid phase in the collecting trays that is optimized in terms of the technical process requirements.

Furthermore, according to a preferred embodiment of the invention, it is provided that the run-off tube forms, at an upper end, a collecting funnel for the liquid phase.

Preferably, said supporting unit, comprising the supporting grid, the guiding elements, the collecting trays and the central run-off tube, is formed integrally from a metal, in particular aluminum, by 3D printing, in particular laser sintering.

Preferably, it is provided that the supporting unit is built up in layers from a material in powder form, in particular comprising a metal, in particular aluminum, specifically from a plurality of layers applied in succession and one above the other, wherein each layer, prior to the application of the next layer, has been heated by means of a laser beam in a predefined region which corresponds to a cross-sectional region of the unit to be produced, and has in the process been fixed on the layer lying thereunder, in particular has been fused to this.

Furthermore, the invention relates to a method for the production of a supporting collector for supporting a packing, in particular of a supporting collector according to the invention as described above, wherein the supporting collector has a plurality of collecting trays for receiving a liquid phase falling from the packing, a plurality of guiding elements which are arranged above the collecting trays and which serve for guiding the falling liquid phase into the collecting trays, a supporting grid which is connected to the guiding elements and which serves for the placement of the packing onto the supporting grid, and also in particular a run-off tube which in particular is fluidically connected to the collecting trays which in particular extend in each case from the collecting tube outward in a radial direction to a periphery of the supporting collector, wherein the supporting grid, the guiding elements, the collecting trays and in particular also the run-off tube are formed integrally on one another and form a supporting unit, wherein the supporting grid, the guiding elements, the collecting trays and in particular also the run-off tube are formed by 3D printing and are formed integrally on one another by the 3D printing, and wherein in particular the supporting unit is formed from a metal, in particular aluminum, by 3D printing, in particular laser sintering.

Preferably, within the scope of the method according to the invention, during the 3D printing, the supporting unit is built up in layers from a material in powder form, in particular comprising a metal, in particular aluminum, wherein a plurality of layers of the material are applied in succession, one above the other, wherein each layer, prior to the application of the next layer, is heated by means of a laser beam in a predefined region which corresponds to a cross-sectional region of the unit to be produced, and is in the process fixed on the layer lying thereunder, in particular is fused to this.

Thus, during the 3D printing, the material is in particular fed in a powder form and connected in an interface-diffusive, that is to say a material-bonding, manner to the already existing part of the unit to be produced. The particles can in this case be completely melted or be connected solely at the surface and therefore to the already existing constituent of the workpiece. A diffusive process takes place at the interfacial surfaces such that, for example, in the case of a metal, particularly preferably aluminum, no interfacial surfaces lie on top of one another in a purely adhesive manner, but rather a continuous crystal structure is formed. Therefore, ideally, no reduced material characteristics occur at the joining surfaces.

The invention described above is explained in detail below against the relevant technical background with reference to the associated drawings, which show preferred refinements and in which:

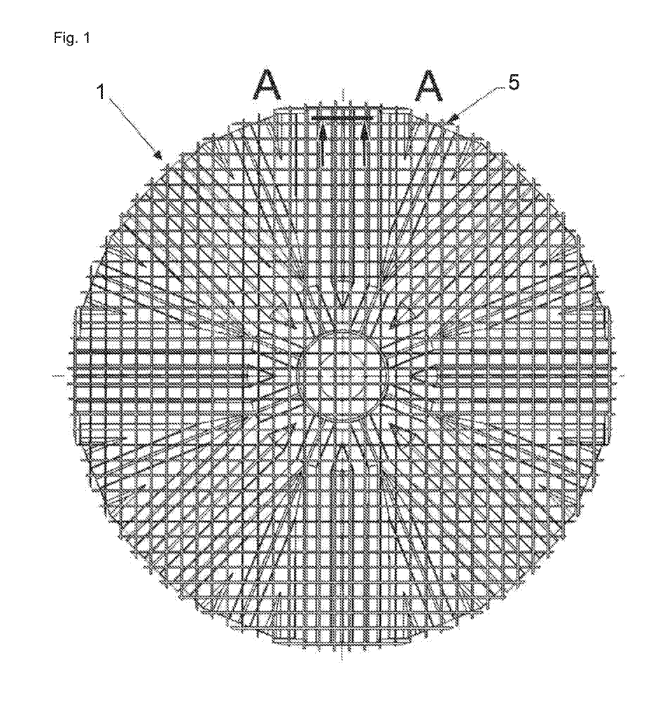

FIG. 1 shows a plan view of a supporting collector according to the invention,

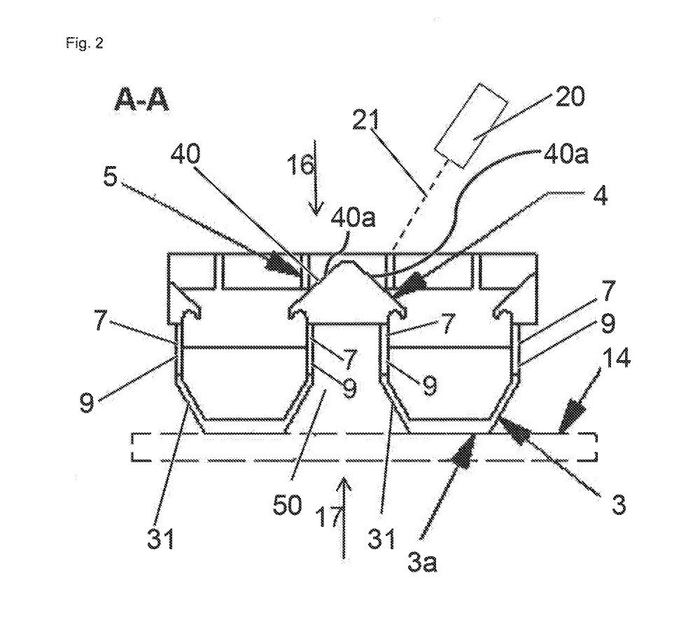

FIG. 2 shows a section along the line A-A of FIG. 1,

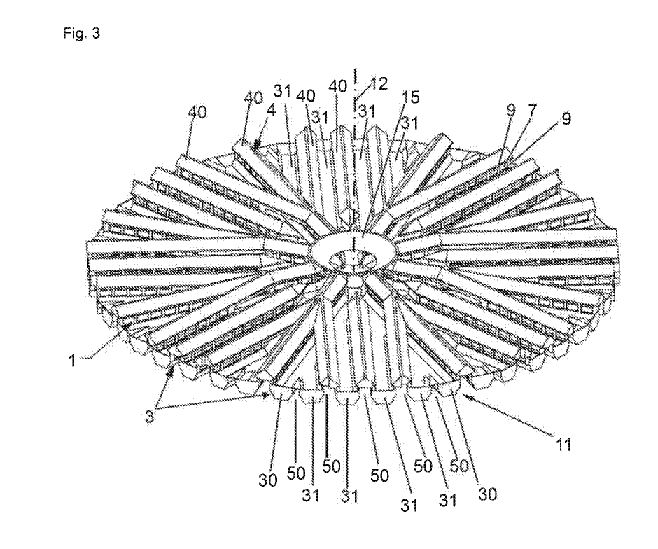

FIG. 3 shows a perspective view, at an angle from above, of the supporting collector without a grid,

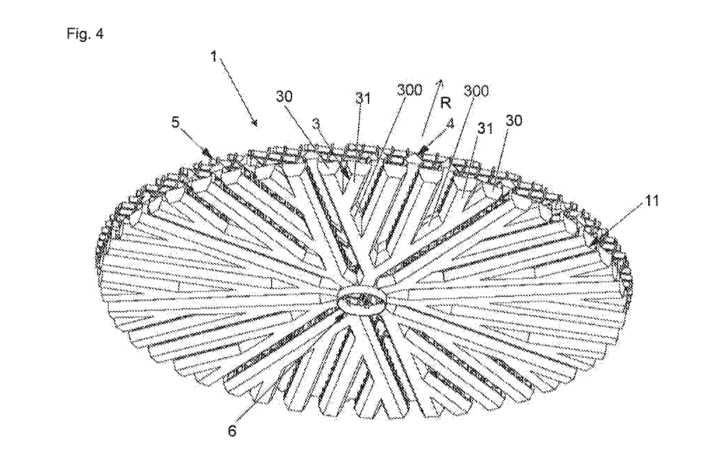

FIG. 4 shows a perspective view, at an angle from below, of the supporting collector with a grid, and

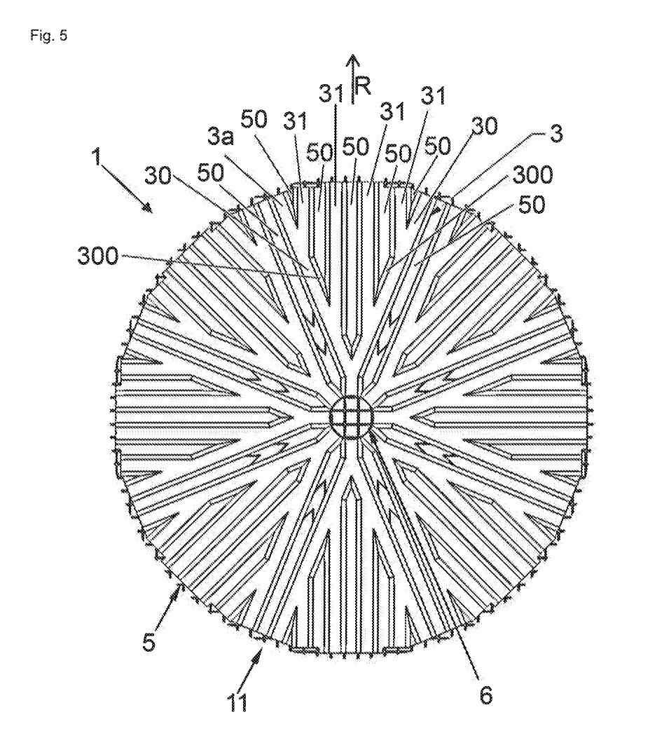

FIG. 5 shows a plan view of the underside of the supporting collector or of the collecting trays of the supporting collector.

FIGS. 1 to 5 show a preferred embodiment of a supporting collector 1 according to the invention.

The supporting collector 1 has a central run-off tube 6 which extends along a longitudinal or cylinder axis 12 which, during operation, coincides with the vertical longitudinal or cylinder axis of a column or packing column in which the supporting collector 1 for supporting a structured packing is to be arranged. Above the run-off tube 6 there is a collecting funnel 15 for catching a liquid phase 16 flowing away from the packing. In particular the liquid phase 16 which falls in the region around the longitudinal or cylinder axis is guided by this collecting funnel 15 into the run-off tube 6. In said region, the collecting funnel 15 replaces the guiding element sections 40 explained further below. A multiplicity of branched collecting trays 3, which open into the run-off tube 6 and are formed integrally thereon, extends, in each case in a radial direction R, from the run-off tube outward to a circular periphery 11 of the supporting collector 1. The collecting trays 3 are preferably designed in the form of troughs and serve for catching a liquid phase 16 falling from the packing. Here, the collecting trays extend in each case—with respect to a supporting collector 1 arranged as intended, which is to be assumed in the following text—along a horizontal plane, and have in this case a slope toward the run-off tube 6. Furthermore, proceeding from the run-off tube 6, the collecting trays 3 branch in each case into two collecting tray sections 30 which extend in each case along a radial direction R to the periphery 11 of the supporting collector 1 and in the process diverge. Here, the two collecting tray sections 30 have in each case a side wall 300, which side walls are facing one another, wherein further collecting tray sections 31 branch off from the two side walls 300 in each case, which sections in particular run parallel to one another and in particular extend in each case along a radial direction R to the periphery 11 of the supporting collector 1. In this way, the collecting trays 3 acquire a tree structure, wherein the liquid phase 16 in the individual collecting tray sections 30, 31, which are fluidically connected to one another, is merged toward the run-off tube 6.

The collecting trays 3 or collecting tray sections 30, 31 are designed as channels that are open at the top, and have in this case an underside 3a via which the collecting tray sections 30, 31 are able to be laid on a supporting ring 14 at an outer end in order to support the supporting collector. A supporting ring 14 of this type may be provided, for example, on the circumferential inner side of a column such that the supporting collector can be supported via the supporting ring and, at the same time, can extend over the entire column cross section.

For allowing the passage of a gaseous phase 17 flowing upward in the column, between the collecting tray sections 30, 31 there are gaps 50 which correspondingly extend outward in each case along a radial direction R to the circumference 11 of the supporting collector 1. It is therefore possible for the gaseous phase 17 to rise up into the packing to be mounted on the supporting collector 1, where it can come into contact with a liquid phase 16 wetting the packing.

In order to deflect a liquid phase 16 falling from the packing to be mounted, the supporting collector has a multiplicity of guiding elements which extend from the run-off tube 6 outward, in each case in a radial direction R, to the periphery 11 of the supporting collector 1, specifically above the collecting trays 3. The guiding elements 4 may likewise branch and have in each case at least one guiding element section 40 which is arranged above an assigned gap 50. The guiding elements 4 or guiding element sections 40 therefore cover the gaps 50 between the collecting tray sections 30, 31 and ensure that a liquid phase 16 trickling down from above is guided into the collecting tray sections 30, 31.

For this purpose, the guiding element sections 40 are formed so as to be of roof-shaped cross section and have here in each case two run-off surfaces 40a which are arranged at an angle to one another and which drop down on both sides such that the liquid phase 16 flowing along the run-off surfaces 40a falls into the collecting tray sections 30, 31. The lower edges of the guiding elements 4 or guiding element sections 40 are preferably designed as drip noses and thereby prevent liquid 16 flowing away through the passage openings 7 and not passing into the collecting trays 3. In particular, the guiding element sections 40 are formed so as to be preferably of triangular cross section, specifically in particular in the form of an isosceles triangle with an upwardly directed apex, whereby a peaked roof or the respective roof profile is formed. The roof profile may furthermore be a solid profile of triangular cross section.

The individual guiding element sections 40 are formed integrally on the assigned collecting tray sections 30, 31 via webs 9 running vertically, wherein between every two adjacent webs 9 there is formed in each case a passage opening 7 through which the gaseous phase 17, which enters into the gaps 50 from below, can flow past the guiding elements 4 in order to pass into the packing. For the purpose of supporting the packing, the supporting collector furthermore has a circular supporting grid 5, the upward-facing bearing surface of which is arranged above the collecting trays 3 and guiding elements 4. Here, the supporting grid 5 is formed integrally on the guiding elements 4. The supporting grid 5 serves for supporting a packing which is directly placed onto the bearing surface of the supporting grid 5.

As shown in FIG. 2, the supporting collector 1 is, according to the invention, built up as an integrally formed unit by 3D printing. Here, the run-off tube 6, the collecting trays 3, the guiding elements 4 and the supporting grid 5 are formed integrally on one another. This may be performed, for example, by means of laser sintering.

The supporting unit 6, 3, 4, 5 is in this case built up in layers from a material in powder form, in particular comprising a metal, in particular aluminum, wherein a plurality of layers of the material are applied in succession, one above the other, wherein each layer, prior to the application of the next layer, is heated by means of a laser beam 21, which is produced by a laser 20, in a predefined region which corresponds to a cross-sectional region of the unit to be produced, and is in the process fixed on the layer lying thereunder, in particular is fused to this.

### LIST OF DESIGNATIONS

| | |
|---|---|
| 1 | Supporting collector |
| 2 | Collecting tray |
| 3a | Underside |
| 4 | Guiding element |
| 5 | Supporting grid |
| 6 | Central run-off tube |
| 7 | Passage opening |
| 9 | Web |
| 11 | Periphery |
| 12 | Longitudinal axis of cylinder axis |
| 14 | Supporting ring |
| 15 | Collecting funnel |
| 16 | Liquid phase |
| 17 | Gaseous phase |
| 20 | Laser |
| 21 | Laser beam |
| 30, 31 | Collecting tray sections |
| 40 | Guiding element sections |
| 40a | Run-off surfaces |
| 50 | Gap |
| 300 | Side wall |
| R | Radial direction |

What I claim is:

1. A supporting collector for supporting a packing, comprising:
a plurality of collecting trays for receiving a liquid phase falling from the packing;
a plurality of guiding elements which are arranged above the collecting trays and which serve for guiding the falling liquid phase into the collecting trays; and
a supporting grid which is connected to the guiding elements and which serves for the placement of the packing onto the supporting grid,
characterized in that
the supporting collector has a central run-off tube which extends along a longitudinal axis, wherein the supporting grid, the guiding elements, the collecting trays and the run-off tube are formed integrally on one another and form a supporting unit, wherein the supporting grid, the guiding elements, the collecting trays and the run-off tube are formed by 3D printing and are formed integrally on one another by the 3D printing, and wherein the collecting trays are fluidically connected to the run-off tube and extend in each case from the collecting tube outward in a radial direction to a periphery of the supporting collector, and wherein, proceeding from the run-off tube, the respective collecting tray branches into two collecting tray sections which extend in each case along a radial direction to the periphery of the supporting collector and in the process diverge.

2. The supporting collector as claimed in claim 1, characterized in that the longitudinal axis runs perpendicularly to the guiding elements and/or to the collecting trays.

3. The supporting collector as claimed in claim 1, characterized in that the two collecting tray sections have in each case a side wall, wherein the two side walls are facing one another, and wherein further collecting tray sections branch off from the two side walls in each case, which sections run parallel to one another.

4. The supporting collector as claimed in claim 1, characterized in that between every two adjacent collecting tray sections there is formed a gap which serves for allowing the passage of a gaseous phase, such that said phase is able to rise up into a packing that is to be placed onto the supporting grid.

5. The supporting collector as claimed in claim 4, characterized in that the guiding elements have in each case at least one guiding element section, which is arranged above an assigned gap such that a liquid phase impinging on the respective guiding element section can flow away from the respective guiding element section and pass into at least one of the two collecting tray sections which run on both sides of the gap above which the respective guiding element section is arranged.

6. The supporting collector as claimed in claim 5, characterized in that the guiding element sections are designed as roof profiles, wherein the guiding element sections have in each case two lower edges which are opposite one another and which are each designed as drip noses.

7. The supporting collector (1) as claimed in claim 5, characterized in that the guiding elements are formed integrally on assigned collecting tray sections via webs, wherein between adjacent webs there is formed in each case a passage opening, for allowing the passage of a gaseous phase, such that said phase is able to rise up into a packing that is to be placed onto the supporting grid.

8. The supporting collector as claimed in claim 1, characterized in that the collecting trays and/or the collecting tray sections have a slope toward the central run-off tube.

9. The supporting collector as claimed in one of claims 1 to 8, characterized in that, in a region above the run-off tube in which no guiding element sections are arranged, there is arranged a collecting funnel which is set up for collecting a falling liquid phase, wherein the collecting funnel is connected directly, integrally, or indirectly to the run-off tube.

10. The supporting collector as claimed in claim 1, characterized in that the supporting unit is formed integrally from a metal, by 3D printing.

11. The supporting collector as claimed in claim 10, characterized in that, during the 3D printing, the supporting unit is built up in layers from a material in powder form, comprising a metal, wherein a plurality of layers of the material are applied in succession, one above the other, wherein each layer, prior to the application of the next layer, is heated by means of a laser beam in a predefined region which corresponds to a cross-sectional region of the unit to be produced, and is in the process fixed on the layer lying thereunder, is fused to this.

12. A method for the production of a supporting collector for supporting a packing, wherein the supporting collector has a plurality of collecting trays for receiving a liquid phase falling from the packing, a plurality of guiding elements which are arranged above the collecting trays and which serve for guiding the falling liquid phase into the collecting trays, a supporting grid which is connected to the guiding elements and which serves for the placement of the packing onto the supporting grid, and also in particular a run-off tube which is fluidically connected to the collecting trays which in particular extend in each case from the collecting tube outward in a radial direction to a periphery of the supporting collector, and wherein the supporting grid, the guiding elements, the collecting trays and also the run-off tube are formed integrally on one another and form a supporting unit, wherein the supporting grid, the guiding elements, the collecting trays and also the run-off tube are formed by 3D printing and are formed integrally on one another by the 3D printing.

13. The method as claimed in claim 12, characterized in that, during the 3D printing, the supporting unit is built up in layers from a material in powder form, comprising a metal, wherein a plurality of layers of the material are applied in succession, one above the other, wherein each layer, prior to the application of the next layer, is heated by means of a laser beam in a predefined region which corresponds to a cross-sectional region of the unit to be produced, and is in the process fixed on the layer lying thereunder, is fused to this.
